(19) United States
(12) Patent Application Publication
(10) Pub. No.: US 2025/0088085 A1
(43) Pub. Date: Mar. 13, 2025

(54) Method For Operating An Electric Motor

(71) Applicant: Vitesco Technologies GmbH, Regensburg (DE)

(72) Inventor: Lukas Kirzinger, Regensburg (DE)

(73) Assignee: Vitesco Technologies GmbH, Regensburg (DE)

(21) Appl. No.: 18/830,018

(22) Filed: Sep. 10, 2024

(30) Foreign Application Priority Data
Sep. 11, 2023 (DE) 10 2023 208 758.8
Aug. 21, 2024 (DE) 10 2024 207 935.9

(51) Int. Cl. H02K 21/02

(52) U.S. Cl. CPC H02K 21/026; H02K 2213/09

(57) ABSTRACT

Various teachings of the present disclosure include a method for operating an electric motor of rotor-stator-rotor configuration and a first gap with a first thickness d1 between a first rotor and a stator and a second gap with a second thickness d2 between the stator and a second rotor, wherein the first rotor and the second rotor are electrically excitable separately from each other. An example includes: detecting a first open-circuit voltage of the first rotor; detecting a second open-circuit voltage of the second rotor; classifying the first open-circuit voltage and the second open-circuit voltage; and adjusting the electrical excitation of at least one from amongst the first rotor and the second rotor based on at least one of the classified open-circuit voltages.

### CROSS-REFERENCE TO RELATED APPLICATIONS

This application claims priority to DE Application No. 10 2024 207 935.9 filed Aug. 21, 2024 and DE Application No. 10 2023 208 758.8 filed Sep. 11, 2023, the contents of which are hereby incorporated by reference in their entirety.

### TECHNICAL FIELD

The present disclosure relates to electric motors. Various embodiments include systems and/or methods for operating an electric motor.

### BACKGROUND

Electric motors, in particular as drives for vehicles, are becoming more and more widespread. In this case, electric motors often have an arrangement of a plurality of stators and/or rotors, which are arranged adjacent to each other on an axis. The assembly is subject to tolerances for design- and production-related reasons. Owing to these tolerances, firstly large air gaps have to be provided between rotor and stator. Secondly, unilateral deviations from the air gaps of nominally identical size can lead to different forces on the components of the assembly. This can, in turn, lead to undesired effects, such as unilateral bearing loading, which is disadvantageous in terms of service life and thus costs, or else in terms of negatively influenced NVH behavior.

DE 10 2020 126 068 A1 relates to an axial flux machine comprising a rotor and two stators axially spaced apart from the rotor. A first stator comprises a first stator winding. A second stator comprises a second stator winding. In order to reduce axial vibrations, a device is provided for generating an axially directed force on the rotor by applying different currents to opposite phase coils of the first and the second stator winding.

The solutions known from the prior art can be yet further improved, in particular with regard to compensating for tolerances of the assembly and reducing the disadvantages associated with them.

### SUMMARY

The teachings of the present disclosure may overcome some of these disadvantages. In particular, various embodiments of the teachings of the present disclosure allow compensation for component tolerances and/or reduction of their disadvantages. For example, some embodiments include a method for operating an electric motor (12), the electric motor (12) being of rotor-stator-rotor configuration and having a first gap (22) with a first thickness d1 between a first rotor (18) and a stator (20) and a second gap (26) with a second thickness d2 between the stator (20) and a second rotor (24), and the first rotor (18) and the second rotor (24) being electrically excitable separately from each other, wherein the method comprises: a) detecting a first open-circuit voltage of the first rotor (18) and detecting a second open-circuit voltage of the second rotor (24); b) classifying the first open-circuit voltage and the second open-circuit voltage; and c) adjusting the electrical excitation of at least one from amongst the first rotor (18) and the second rotor (24) based on at least one of the classified open-circuit voltages.

In some embodiments, classification according to method step b) is performed based on a difference between the open-circuit voltages.

In some embodiments, classification according to method step b) is performed based on predefinable limit values.

In some embodiments, the predefinable limit values relate to an asymmetry of the first thickness d1 and the second thickness d2.

In some embodiments, the first rotor (18) and the second rotor (24) are excited asymmetrically in element c).

In some embodiments, the method is carried out at predefinable operating points during operation of an electric motor (12).

In some embodiments, the electric motor (12) is an axial flux machine.

As another example, some embodiments include a computer program product comprising commands which, when the program is executed by a computer, prompt the latter to carry out one or more of the methods as described herein.

As another example, some embodiments include an electric drive system (10), comprising an electric motor (12), the electric motor being of rotor-stator-rotor configuration and having a first gap (22) with a first thickness d1 between a first rotor (18) and a stator (20) and a second gap (26) with a second thickness d2 between the stator (20) and a second rotor (24), and the first rotor (18) and the second rotor (24) being electrically excitable separately from each other, wherein the drive system (10) has a control unit (14), which is designed to carry out one or more methods as described herein.

In some embodiments, the electric motor (12) is an axial flux machine.

### BRIEF DESCRIPTION OF THE DRAWINGS

The teachings herein are explained in more detail below with reference to the figures, where individual or multiple features of the figures may be a feature of the invention alone or in combination. Furthermore, the figures are only to be viewed as examples but in no way restrictive.

FIG. 1 shows an electric drive system incorporating teachings of the present disclosure; and

FIG. 2 shows a detailed view of an electric motor for a drive system from FIG. 1.

### DETAILED DESCRIPTION

Various embodiments of the teachings herein include a method for operating an electric motor having a rotor-stator-rotor configuration and a first gap with a first thickness d1 between a first rotor and a stator and a second gap with a second thickness d2 between the stator and a second rotor, and the first rotor and the second rotor being electrically excitable separately from each other, the method comprising:
a) detecting a first open-circuit voltage of the first rotor and detecting a second open-circuit voltage of the second rotor;
b) classifying the first open-circuit voltage and the second open-circuit voltage; and
c) adjusting the electrical excitation of at least one from amongst the first rotor and the second rotor based on at least one of the classified open-circuit voltages.

Construction-related tolerances, in particular of the rotor-stator-rotor assembly, can be compensated for or their disadvantages can be reduced or prevented entirely. The methods described herein are may therefore be used to operate an electric motor.

The electric motor is of rotor-stator-rotor configuration. A configuration of this kind means, in particular, that the electric motor has a first gap with a first thickness d1 between a first rotor and a stator and a second gap with a thickness d2 between the stator and a second rotor in this configuration. The stator and the rotors are expediently arranged on one axis, the first rotor and the second rotor being arranged axially oppositely adjacent to the stator. In this case, the first rotor and the second rotor are electrically excitable separately from each other. This can be done, in particular, by applying current to the first and/or the second rotor, it being possible for current to be applied to the rotors independently of each other. For this purpose, the rotors have a coil, which can run continuously through the rotors, in particular in corresponding windings. The stator can also be actively excitable. However, in principle, it is not possible to rule out the stator having one or more passive magnets.

For example, the electric motor can be an axial flux machine (AFM) having two rotors, also referred to as a double rotor, which is of rotor-stator-rotor configuration. Owing to the technology involved, two rotor disks, both outside the stator, are provided in axial flux machines, these being regarded as two rotors within the meaning of the invention.

However, in principle, radial flux machines (REM) with electrical excitation in the rotor are also conceivable and covered by the scope of the disclosure. For example, for construction-related reasons, the thickness d1 of the first gap may differ from the thickness d2 of the second gap. A first open-circuit voltage of the first rotor is detected and a second open-circuit voltage of the second rotor is detected. The open-circuit voltage of both rotors of the rotor-stator-rotor configuration is thus determined. This is readily possible with the aid of already included measurement systems and electronics, which are used to control the application of current.

The first open-circuit voltage and the second open-circuit voltage are then classified. Classification can be performed in various ways here, as will be explained in detail below. The open-circuit voltage indicates the distance between the rotor in question and the stator. In other words, the first open-circuit voltage is indicative of the distance d1 and the second open-circuit voltage is indicative of the distance d2.

The electrical excitation of at least one rotor is adjusted based on at least one of the classified open-circuit voltages. This means that the excitation is not simply based on a predefined value, but that the classification of the first and/or the second open-circuit voltage is taken into account when adjusting the excitation of the first and/or the second rotor. This step can be performed, for example, by means of corresponding closed-loop control in the inverter, for example by reducing or increasing the voltage. In some embodiments, it is also possible to enable hardware-based implementation by means of an adapted series resistor in the excitation circuit.

An indication may be made about the distance of each of the rotors from the stator on the basis of the open-circuit voltage of the respective rotors. It may be sufficient here to draw conclusions, for example, about a difference between the thicknesses d1 and d2, also referred to as gap thicknesses, based on a difference between the open-circuit voltages.

An asymmetrical structure, which is shown by way of different gap thicknesses d1 and d2, can lead to disadvantages. Asymmetries of this kind can occur in electric motors for design- and production-related reasons since the assembly comprising a stator and rotors is subject to certain tolerances. Owing to these tolerances, firstly large air gaps have to be provided between rotor and stator. Secondly, unilateral deviations from the air gaps of nominally identical size can lead to different forces on the components of the assembly. This can, in turn, lead to undesired effects, such as to unilateral bearing loading, which is disadvantageous in terms of service life and thus costs, or also to negatively influenced NVH behavior.

If current is then applied to at least one rotor, and said rotor is thus excited, based on at least one of the classified open-circuit voltages, these effects can be effectively counteracted. It has thus been shown that excitation of at least one rotor, e.g. both rotors, based on the classification allows the disadvantages that arise in particular owing to an asymmetry to be effectively counteracted.

In some embodiments, given uniform excitation of the first rotor and the second rotor and an asymmetrical gap thickness, the rotors act on the stator with different forces. Since this respective force depends on the magnetic flux of the first rotor and, respectively, the second rotor in addition to the gap thickness d1 and d2, the magnetic flux and thus ultimately the active force can be adjusted by asymmetrical application of current to the rotors. This can improve the forces acting on the bearings and also the NVH behavior. This allows the bearing loading on the rotors to be reduced, and this can significantly increase the service life of the corresponding assembly.

This also results in improved what is known as NVH behavior (noise, vibration, harshness). Accordingly, the operation of a vehicle comprising a correspondingly operated electric motor can also be significantly improved and made particularly comfortable for passengers. This may also result in advantages in the production of systems of this kind. This is because less exacting tolerances for gap thicknesses may potentially be possible by counteracting different gap thicknesses since disadvantages that occur can be effectively counteracted in this way. Equally, the components can be designed to be smaller.

In principle, the performance can also be improved owing to a possible reduction in the air gap thickness. In addition, the forces acting on the rotors can be reduced.

The methods described herein may be simple in comparison to a stator-rotor-stator configuration. In that case, open-loop control of the excitation would be much more complicated, and therefore the methods described herein are distinguished by simplicity and thus also by a greatly reduced susceptibility to faults.

In some embodiments, classification according to b) is performed based on a difference between the open-circuit voltages, that is to say the first open-circuit voltage and the second open-circuit voltage. In this refinement, use can thus be made of the fact that it is not absolutely necessary to determine the absolute gap thicknesses d1 and d2, but rather that it is sufficient to determine a difference between the thicknesses d1 and d2 in order to achieve the advantages described herein. Accordingly, this refinement may be particularly easy to carry out.

In some embodiments, classification according to b) is performed based on predefinable limit values. The method can also be formulated in a particularly simple manner since no complex computing operations are necessary, but rather comparatively simple and low-error comparison with predefinable data can be made. This may also be possible in a particularly simple manner in the above-described refinement, according to which classification according to method step b) is performed based on a difference between the open-circuit voltages, since it is easy to check whether the difference is in a predetermined value range or not.

In some embodiments, the predefinable limit values relate to an asymmetry of and thus a difference between the first thickness d1 and the second thickness d2. As described above, the limit values in this case can define a range in which the thicknesses are the same or exhibit a tolerable difference. In particular, the above-described disadvantages can be effectively counteracted by counteracting an asymmetry. Accordingly, a difference between the open-circuit voltages can be assigned to an asymmetry, that is to say a different gap thickness. This may be possible by way of the limit values being determined on the basis of appropriate tests or else being provided by simulations.

In particular, if asymmetry is present, it may be advantageous, in c), for the first rotor and the second rotor to be excited asymmetrically, that is to say with different intensities. This is because different or asymmetrical excitation can effectively and precisely controllably counteract disadvantages created by different gap thicknesses d1 and d2. For example, the excitation can be reduced in one rotor and/or increased in the second rotor, starting from a fundamentally planned excitation or an excitation to be carried out. In principle, the level of adjustment for the excitation is dependent on the respective open-circuit voltage or its classification, and thus, for example, on the degree of asymmetry.

In some embodiments, the method is a calibration method which is carried out at predefinable operating points during operation of an electric motor. In this refinement, the method can be carried out periodically at specified operating points, for example during starting or commissioning of the electric motor, during servicing or else during operation, that is to say by means of specialized control in real time during operation or when faults occur. As a result, a different gap thickness can be identified in principle and this can be counteracted. However, it is also possible that the excitation of the rotors is executed for a certain period of time based on the classified data without further control, that is to say without carrying out the methods described herein, since the risk of a changing gap thickness may be negligible after short operating times.

Some embodiments of the teachings herein include a computer program product comprising commands which, when the program is executed by a computer, prompt the latter to carry out one or more of the methods as described above. A computer program product of this kind can be loaded, for example, onto a control unit of the electric motor or a control unit for the electric motor and include control commands which initialize the steps of the method described here. Accordingly, the control unit can, for example, initialize corresponding measurements and control the excitation of the rotors, as is described above with reference to the method.

A computer program product of this kind provides the resulting disadvantages, such as an increased bearing load and a negatively influenced NVH behavior for example, can be counteracted by detecting, in particular, different gap thicknesses between the stator and the rotors.

Some embodiments of the teachings herein include an electric drive system comprising an electric motor, the electric motor of rotor-stator-rotor configuration and having a first gap with a first thickness d1 between a first rotor and a stator and a second gap with a second thickness d2 between the stator and a second rotor, and the first rotor and the second rotor being electrically excitable separately from each other, the drive system comprising a control unit designed to carry out a method as described herein.

With regard to the electric motor, reference is made to the description above. The electric motor may be an axial flux machine, but should not be limited to this. The drive system now has a control unit, which may be part of the electric motor or connected to the electric motor and is designed to carry out the described method. For this purpose, for example, a computer program product described above can be loaded onto the control unit or a device for data processing contained in the control unit.

The resulting disadvantages, such as an increased bearing loading and a negatively influenced NVH behavior for example, can be counteracted by detecting, in particular, different gap thicknesses between the stator and the rotors. In particular, the following features can be combined individually or in any combination with the abovementioned subject matter:

For example, the first thickness may differ from the second thickness. In other words, the distances of the two rotors from the stator may differ. Furthermore, this difference may be due to manufacturing deviations or manufacturing tolerances. In other words, it may be preferred if this difference is a static or constant difference between the two thicknesses.

In addition, it may be preferred that the first rotor has a first rotor winding, in particular for excitation of the first rotor.

In some embodiments, the second rotor has a second rotor winding, in particular for excitation of the second rotor.

In some embodiments, the stator has a stator winding and/or is free of permanent magnets.

The first rotor, in particular the first rotor winding, can be excited by means of a first voltage, a first DC voltage or a first DC voltage level, e.g. by way of the first voltage, the first DC voltage or the first DC voltage level being applied to the first rotor winding.

The second rotor, in particular the second rotor winding, can be excited by means of a second voltage, a second DC voltage or a second DC voltage level, e.g. by way of the second voltage, the second DC voltage or the second DC voltage level being applied to the second rotor winding.

The first voltage, the first DC voltage or the first DC voltage level can differ, in particular in terms of its value or its level, from the second voltage, the second DC voltage or the second DC voltage level.

The first voltage, first DC voltage or first DC voltage level can be higher than the second voltage, second DC voltage or second DC voltage level if the first thickness is greater than the second thickness.

The second voltage, second DC voltage or second DC voltage level can be higher than the first voltage, first DC voltage or first DC voltage level if the second thickness is greater than the first thickness.

The first voltage, first DC voltage or first DC voltage level can be proportional to the first thickness, while the second voltage, second DC voltage or second DC voltage level can be proportional to the second thickness.

The first voltage, first DC voltage or first DC voltage level can be provided by a first DC voltage source or a first voltage regulator and/or the second voltage, second DC voltage or second DC voltage level can be provided by a second DC voltage source or a second voltage regulator.

The DC voltage sources or DC voltage regulators can be operated and/or subject to open-loop control and/or closed-loop control independently of each other, in particular in order to provide the corresponding and/or different voltage, DC voltage or DC voltage level for the rotor windings.

The DC voltage sources or DC voltage regulators can be integrated in an inverter. The inverter can serve the stator, in particular the stator winding, as a voltage source, e.g. for three-phase current or three-phase voltage.

The open-circuit voltage can be measured by means of the rotor windings, in particular by way of measuring the voltages induced in the rotor windings. Voltage or current sensors, which measure the induced voltage, in particular open-circuit voltage, can be provided for this purpose.

In comparison to what are known as stator-rotor-stator arrangements, the embodiments described herein allow independent excitation of the two rotors, in particular rotor windings, of the rotor-stator-rotor arrangement, as a result of which the different thicknesses of the gaps can be individually addressed in order to compensate for them during operation.

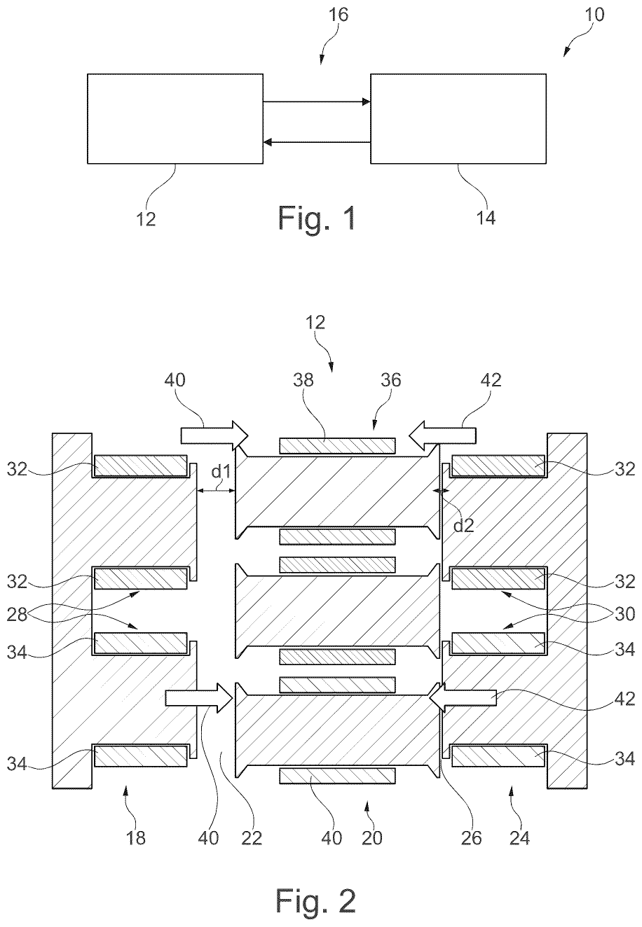

FIG. 1 shows, in schematic form, an electric drive system 10 incorporating teachings of the present disclosure which can be used, for example, in an electrically driven vehicle. The drive system 10 comprises, in principle, an electric motor 12 and a control unit 14, which is connected to the electric motor 12 via a data connection 16. The control unit 14 can influence the operation of the electric motor 12 and capture data relating to functioning of the electric motor 12 by way of the data connection 16.

A detailed view of the electric motor 12 is shown in FIG. 2. The electric motor 12 is of rotor-stator-rotor configuration and is designed, in particular, as an axial flux machine. Accordingly, the electric motor 12 or the rotor-stator-rotor configuration has a first gap 22 with a first thickness d1 between a first rotor 18 and a stator 20 and a second gap 26 with a thickness d2 between the stator 20 and a second rotor 24. The first rotor 18 and the second rotor 24 each comprise a correspondingly wound coil 28, 30 for forming different poles 32, 34. Accordingly, the first rotor 18 and the second rotor 24 are electrically excitable separately from each other by corresponding application of current.

It is further shown that the stator 20 also has a coil 36 in order to be electrically excited with formation of different poles 38, 40. However, the stator 20 can also comprise a permanent magnet in principle.

The thicknesses d1 and d2 are often different for construction-related reasons, as a result of which, given uniform excitation of or application of current to the first rotor 18 and the second rotor 24, the rotors 18, 24 act on the stator 20 with different forces, shown by the arrows 42, 44. Since this respective force depends on the magnetic flux of the first rotor 18 and, respectively, the second rotor 24 in addition to the gap thickness d1 and d2, the magnetic flux and thus ultimately the active force can be adjusted by asymmetrical application of current to the rotors 18, 24. This can improve the forces acting on the bearings and also the NVH behavior. For this purpose, it is possible to draw conclusions about any asymmetry between the gap thicknesses d1 and d2 on the basis of the open-circuit voltages.

A method to be correspondingly applied, which may be a calibration method comprising:
a) detecting a first open-circuit voltage of the first rotor 18 and detecting a second open-circuit voltage of the second rotor 24;
b) classifying the first open-circuit voltage and the second open-circuit voltage, in particular based on a difference between the open-circuit voltages and based on predefinable limits values; and
c) adjusting the electrical excitation of at least one from amongst the first rotor 18 and the second rotor 24 based on at least one of the classified open-circuit voltages, the first rotor 18 and the second rotor 24 being asymmetrically excited in c).

In some embodiments, the limit values relate to an asymmetry of the first distance d1 and the second distance d2.

1. A method for operating an electric motor of rotor-stator-rotor configuration and a first gap with a first thickness d1 between a first rotor and a stator and a second gap with a second thickness d2 between the stator and a second rotor, wherein the first rotor and the second rotor are electrically excitable separately from each other, the method comprising:
detecting a first open-circuit voltage of the first rotor;
detecting a second open-circuit voltage of the second rotor;
classifying the first open-circuit voltage and the second open-circuit voltage; and
adjusting the electrical excitation of at least one from amongst the first rotor and the second rotor based on at least one of the classified open-circuit voltages.

2. The method as claimed in claim 1, wherein classification includes a difference between the open-circuit voltages.

3. The method as claimed in either of claim 1, wherein classification includes predefinable limit values.

4. The method as claimed in claim 3, wherein the predefinable limit values relate to an asymmetry of the first thickness d1 and the second thickness d2.

5. The method as claimed in claim 1, wherein the first rotor and the second rotor are excited asymmetrically.

6. The method as claimed in any of claim 1, wherein the method is carried out at predefinable operating points during operation of an electric motor.

7. The method as claimed in claim 1, wherein the electric motor comprises an axial flux machine.

8. An electric drive system comprising:
an electric motor of rotor-stator-rotor configuration with a first gap with a first thickness d1 between a first rotor and a stator and a second gap with a second thickness d2 between the stator and a second rotor; and
wherein the first rotor and the second rotor are electrically excitable separately from each other; and
a control unit programmed to:
detect a first open-circuit voltage of the first rotor;
detect a second open-circuit voltage of the second rotor;
classify the first open-circuit voltage and the second open-circuit voltage; and
adjust the electrical excitation of at least one from amongst the first rotor and the second rotor based on at least one of the classified open-circuit voltages.

9. The electric drive system as claimed in claim 8, wherein the electric motor comprises an axial flux machine.
